(19) United States
(12) Patent Application Publication
(10) Pub. No.: US 2019/0369057 A1
(43) Pub. Date: Dec. 5, 2019

(54) DRONE-CARRIED PROBE STABILIZATION VIA ELECTROMAGNETIC ATTACHMENT

(71) Applicant: Amerapex NDT LLC, Houston, TX (US)

(72) Inventors: Rami Mattar, Houston, TX (US); Remy Kalai, Houston, TX (US)

(73) Assignee: Amerapex NDT LLC, Houston, TX (US)

(21) Appl. No.: 16/426,869

(22) Filed: May 30, 2019

Related U.S. Application Data
(60) Provisional application No. 62/678,039, filed on May 30, 2018.

(51) Int. Cl. G01N 29/22; H01F 7/20; G01N 29/32; G01N 27/00; B64C 39/02; B64D 47/00

(52) U.S. Cl. CPC G01N 29/226; H01F 7/20; G01N 29/32; H01F 2007/062; B64C 39/024; B64D 47/00; G01N 27/00

(57) ABSTRACT

A drone may be flown into proximity of a structure to measure one or more parameters of the structure. An electromagnet of the drone may be activated to electromagnetically attach the drone to the structure for inspection. A probe may be activated to inspect the structure by measuring one or more parameters of the structure.

### CROSS-REFERENCE TO RELATED PATENT APPLICATIONS

This application claims the benefit of priority of U.S. Provisional Patent No. 62/678,039 to Rami Mattar et al. filed on May 30, 2018, and entitled “Wall-Sticking Drone For Non-Destructive Ultrasonic And Corrosion Testing,” which is hereby incorporated by reference herein.

### FIELD OF THE DISCLOSURE

The instant disclosure relates to drone-based measurement systems. More specifically, portions of this disclosure relate to stabilization of a drone-carried measurement probe via electromagnetic attachment.

### BACKGROUND

Structures used in industrial applications, such as facilities and/or equipment, may degrade over time and may require periodic testing to detect any faults that may develop over time as a result of natural degradation, wear and tear, and other factors. Examples of facilities and/or equipment that may require testing include oil and gas refineries, petrochemical plants, power plants, and infrastructure associated with offshore assets such as offshore drilling platforms. For example, piping used in large-scale chemical plants may degrade over time, and thus may require testing to detect potential failures that may lead to unsafe conditions and/or inoperability of equipment and facilities. Such structures may be located in hard to reach or areas that may expose testers to safety risks. Furthermore, such testing can often be time-consuming and expensive, requiring hours of specialized training, facility downtime, enhanced insurance requirements, and/or expensive safety equipment.

Guidelines for facility and equipment safety, established by industry or government, may require periodic testing to verify structural integrity and other structure and equipment operating parameters. Furthermore, standards for equipment and facilities may change over time and may thus require testing after a facility and/or equipment is in operation. Industry standards and governments may require occasional inspections to ensure that structures adhere to environmental, chemical, and/or biological guidelines. Manual inspections may place personnel at significant risk to their health, as structures may be located in areas that may expose personnel to environmental, chemical, and/or biological risks and may be difficult to reach. For example, industry standards, government regulations, and/or company guidelines may require periodic inspections areas of facilities where harmful chemicals and/or gases may be present. In another example, inspection of offshore oil drilling platforms may expose personnel hazardous environmental factors. Still other structures, such as wind turbine blades, can present situations where inspection by personnel may create substantial risks for personnel safety. Furthermore, some facilities may require downtime in order for personnel to reach a testing location and conduct tests.

Shortcomings mentioned here are only representative and are included simply to highlight that a need exists for improved sensing techniques. Embodiments described herein address certain shortcomings but not necessarily each and every one described here or known in the art. Furthermore, embodiments described herein may present other benefits than, and be used in other applications than, those of the shortcomings described above.

### SUMMARY

A drone including one or more probes may activate an electromagnet to attach to a metallic structure, sometimes referred to as “wall-sticking,” for sensing one or more parameters of the structure. For example, a drone may include one or more probes, such as electromagnetic or acoustic probes, for measuring parameters of a metallic structure, such as structural integrity. In order to stabilize the one or more probes while measuring the parameters of the structure, the drone may position itself to place an electromagnet of the drone in contact with the structure. The drone may activate the electromagnet to attach the drone to the magnetic structure and may subsequently begin measuring one or more parameters of the structure using the probe. In some operations, the one or more probes may also be in contact with the structure when the electromagnet is activated. The drone may include a stabilization system to minimize movement of the drone while structural parameters are being measured. In addition, the drone may include an articulating module, to allow for minor movements of the drone with respect to the electromagnet and/or probes in contact with the structure while parameters are measured. Thus, a drone with one or more probes may maintain the probes at a stable position on or near a structure while parameters are measured, allowing for accurate measurement. In some embodiments, the drone may include a reservoir containing conducting gel that is injected onto the probe surface when contacting the structure to improve measurements performed on the structure.

A drone for measuring structural parameters may be operated remotely to move to position and measure structural parameters, may be automated to move to position and measure structural parameters, or a combination of the two. A method for measuring structural parameters with a drone using one or more probes may begin with flying a drone into proximity of a metal structure for inspection. For example, an electromagnet and a probe may be located at an end of an arm extending from a main body of a drone. Flying the drone into proximity of the metal structure may include positioning the electromagnet and/or probe to be in contact with the metal structure.

Once the drone is in proximity of the metal structure, an electromagnet of the drone may be activated to electromagnetically attach the drone to the metal structure for inspection. In some embodiments, an operator may transmit an instruction to the drone to activate the electromagnet, while in other embodiments the drone may automatically activate the electromagnet.

Once the drone is electromagnetically attached to the metal structure, a probe carried by the drone may be activated to inspect the metal structure by measuring a parameter of the metal structure. The probe may, for example, be an electromagnetic probe and/or an acoustic probe configured to collect electromagnetic and/or acoustic data. For example, the probe may measure at least one of mechanical integrity, wall thickness, porosity, material composition, and corrosion level of the structure. The measured parameter may be transmitted to a remote location, such as a base station controlled by an operator.

The drone may maintain contact between the electromagnet and/or the probe and the metal structure by flexibly adjusting an angle at which the electromagnet is attached to the arm of the drone based on motion of the drone relative to a point at which the electromagnet is electromagnetically attached to the metal structure. For example, the electromagnet and/or the probe may be attached to the drone via a flexible mechanism, such as an articulating module, that allows a degree of movement of the drone while the electromagnet and/or probe in contact with the metal structure remain in a stable position. The drone may also avoid movement by dampening external forces applied to the drone, such as by adjusting blade speed and/or angle to account for wind speed.

A drone may carry a payload containing an electromagnet and a probe. The probe and electromagnet may be exposed on a common surface. For example, the probe and electromagnet may be positioned such that the probe is in contact with a structure when the electromagnet is in contact with the structure.

The payload may include an articulating module, allowing the common surface a degree of freedom of movement with respect to the drone. The articulating module may allow the common surface six degrees of freedom of movement. For example, when the electromagnet is electromagnetically attached to a metal structure, the articulating module may allow for slight movements of the drone, while the electromagnet and/or probe are maintained in position against the metal structure. The articulating module may, for example, include a first rigid attachment module configured to attach to the common surface and a second rigid attachment module configured to attach to the drone. The first and second rigid attachment modules may be coupled to each other via one or more elastic cables. The elastic cables may have a predetermined mechanical memory such that the first rigid attachment module maintains a fixed position relative to the second rigid attachment module unless a force greater than a predetermined force is exerted on the second rigid attachment module relative to the first rigid attachment module. Thus, the one or more elastic cables may allow the common surface and the first rigid attachment module to remain in a constant position, in spite of slight movements of the second rigid attachment module and the drone.

The payload may further include an arm configured to attach the common surface to a main body of the drone such that the common surface, the electromagnet, and the probe are extended from the main body of the drone. In some embodiments, an articulating module may connect the common surface to the arm.

A drone may include a first electromagnet for electromagnetically attaching the drone to a surface of a metal structure and a probe for measuring one or more parameters of the metal structure. The first electromagnet and the probe may be located on a common surface such that the electromagnet and the probe are in contact with the metal structure when the drone is electromagnetically attached to the metal structure. An articulating module may be coupled between the common surface and the drone to allow the common surface freedom of movement with respect to a main body of the drone. The articulating module may be coupled between the common surface and an arm extending from the main body of the drone.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1A is an illustration of an example drone system used in a storage tank facility according to some embodiments of the disclosure.

FIG. 1B is an illustration of an example drone system used in a wind power generation facility according to some embodiments of the disclosure.

FIG. 2 is a perspective view of an example drone for measuring structure parameters according to some embodiments of the disclosure.

FIG. 3 is a perspective view of an example drone having an ultrasonic sensor probe for measuring structure parameters according to some embodiments of the disclosure.

FIG. 4 is a series of perspective views of a mounting bracket for mounting one or more electromagnets and one or more probes according to some embodiments of the disclosure.

FIG. 5 is a series of perspective views of an example articulating module for coupling electromagnets and/or probes to a drone according to some embodiments of the disclosure.

FIG. 6 is a perspective view of an example drone having an electromagnetic sensor probe for measuring structure parameters according to some embodiments of the disclosure.

FIG. 7 is a perspective view of an example drone having an electromagnetic sensor probe and an X-Y encoder plotter according to some embodiments of the disclosure.

FIG. 8 is a perspective view of an example drone having an eddy current probe according to some embodiments of the disclosure.

FIG. 9 is a flow chart of an example method for measuring parameters of a metal structure using one or more drone-carried probes according to some embodiments of the disclosure.

FIG. 10 is a block diagram of an example drone payload in communication with a base station according to some embodiments of the disclosure.

### DETAILED DESCRIPTION

Drones may easily access hazardous areas that may require special training, equipment downtime, and/or exposure to elevated risk levels when accessed by personnel. Structures such as industrial structures, civil structures, resource extractions structures, and other structures may require periodic testing to determine if structural parameters, such as structural integrity parameters, meet standards set by governments, standard setting organizations, or companies. Many structural areas that require testing may be difficult, dangerous, time-consuming, and or expensive for access by humans. Thus, a drone carrying one or more probes may access an area of a structure to be tested and may measure one or more parameters of the structure, without requiring presence of a human at the measurement location. In order to stabilize the drone while measuring structural parameters, particularly with respect to metal structures, the drone may activate an electromagnet to electromagnetically attach itself to the structure while parameters are measured, allowing for stable placement of measurement probes for obtaining accurate measurements. For example, drones may be used to measure parameters of a variety of industrial structures, such as chemical processing structures, storage structures, power plants, wind turbines, solar plants, oil and gas processing structures, chemical storage structures, offshore oil drilling platforms, and civil structures such as bridges, shipping vessels, and buildings.

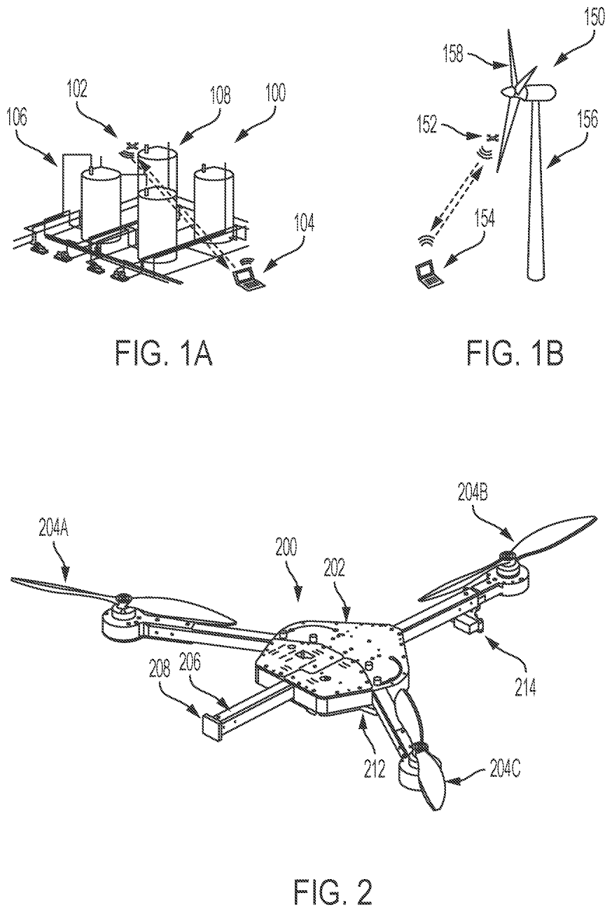

An example above-ground storage facility 100 is shown in FIG. 1A. The above-ground storage facility 100 may include a plurality of above-ground storage tanks, such as tank 108, and pipeline networks, such as pipeline network 106, for piping substances into and out of the storage tanks. A drone 102, such as an unmanned aerial vehicle (UAV) may be used to measure one or more parameters of structures of the facility. The drone 102 may, for example, be a tri-copter, quad-copter, or other type of drone and may inspect structures of the facility, such as tank 108 and pipeline network 106. The drone 102 may be a vertical take-off and landing (VTOL) drone. The drone 102 may use an attached probe (not shown here) to measure one or more parameters of structures of the storage facility, such as mechanical integrity, wall thickness, porosity, material composition, and corrosion level, using electromagnetic or acoustic probes. The drone 102 may communicate wirelessly with a base station 104. The base station 104 may be located at the facility or at a remote location. For example, the base station 104 may be a laptop computer, a tablet, a smart phone, a desktop computer, a data center, a wireless relay, a wireless router, or other information processing device. The drone 102 may operate autonomously to measure parameters of structures of the facility 100 and may transmit measurement data to the base station 104 in real time. Alternatively or additionally, on-site or remote personnel may use base station 104 to control the drone 102 to measure structural parameters of structures of the facility 100. In some cases, use of a drone to measure parameters of facility 100 may be advantageous over manual human-based testing, as manual testing may be hazardous and difficult for the human, and costly, requiring special training for the human. For example, manual access to upper locations of storage tanks and/or pipeline networks may require rope access and/or scaffolding to provide a human access to the inspection site.

A drone may also be used to measure structural parameters of structures of other facilities. For example, FIG. 1B shows a wind turbine 150 having a tower 156 and a plurality of blades, such as blade 158. A drone 152 may measure structural parameters of the tower 156 and the blades, such as blade 158, of the wind turbine. Use of a drone to measure properties of the wind turbine may be advantageous over manual measurements, as obtaining manual measurements may expose personnel to risky conditions given the heights and wind levels present at many turbines.

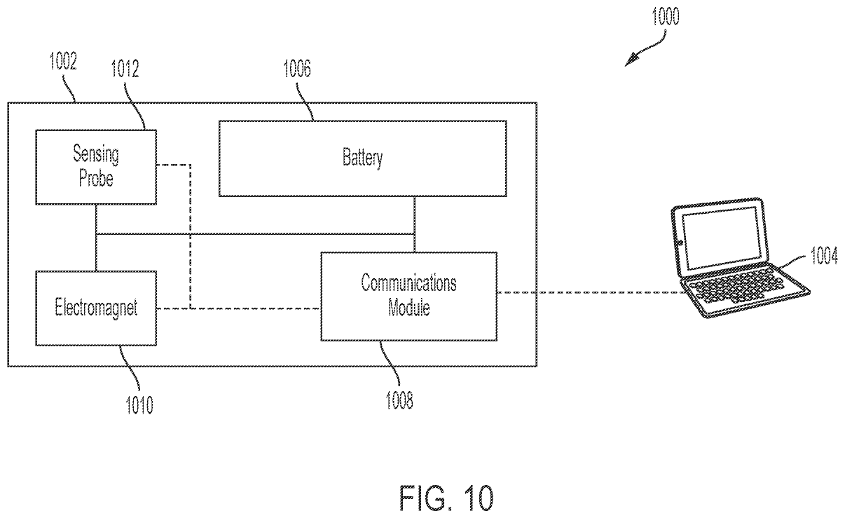

A payload containing electronics such as a power supply, sensing equipment, and communications equipment may be carried by a drone. In some embodiments the components of the payload may be integrated in the structure of the drone, while in other embodiments the payload as a whole may be detachable from the drone. An example system 1000 including a payload 1002 in communication with a base station 1004 is shown in FIG. 10. A payload 1002 may, for example, include a battery 1006 for powering payload equipment. The battery 1006 may also power drone equipment, such as one or more propellers of the drone and/or one or more actuators controlling drone propeller torque. In some embodiments, no battery is present in the payload 1002, and the payload 1002 connects with the drone to receive power from a battery in the drone. The payload 1002 may include a sensing probe 1012, such as an electromagnetic sensing probe or an acoustic sensing probe. In some embodiments, the payload 1002 may include multiple sensing probes, sometimes in excess of five sensing probes. The sensing probe 1012 may be an interchangeable data acquisition device that may be removed from the payload 1002 and replaced with other data acquisition devices. Probes, such as sensing probe 1012, may be positioned to be in contact with a structure when the drone carrying the payload 1002 is magnetically attached to the structure. The payload 1002 may include one or more electromagnets, such as electromagnet 1010, for attaching the drone to a metal structure. The payload 1002 may also include a communications module 1008 for communicating with base station 1004. For example, the communications module 1008 may transmit measurement data from the sensing probe 1012 to the base station 1004. Additionally, the communications module 1008 may receive control information, such as information for controlling the electromagnet and/or drone, from the base station 1004. In some embodiments, a separate communications interface is present in the drone for receiving control information and the measurement data is transmitted on a separate channel from the control information. The battery 1006 may also power the communications module 1008, the electromagnet 1010, and the sensing probe 1012. Portions of the payload, such as sensing probe 1002 and/or electromagnet 1010, may be modularized for rapid exchange. A drone may also carry other equipment, such as a global positioning system (GPS) unit, lasers, wind sensors, and/or other positioning equipment which may, in some embodiments, be included in the payload 1002. Such equipment may be used to stabilize the drone, dampening motion, and/or instability, while measurements are taken using sensing probe 1012.

In some embodiments, a drone carrying one or more sensing probes may be a tri-copter, although other drones may be used. An example drone 200 for carrying sensing equipment is shown in FIG. 2. A drone 200 may include a main body 202, which may support a payload, as described with respect to FIG. 10. In some embodiments, the main body may house electronic equipment, such as one or more batteries for powering the drone, and positioning equipment, such as lasers, GPS, and wind sensors, for stabilizing the drone and dampening movement of the drone while measurements are being taken. The drone 200 may meet various safety requirements, and may operate with minimal or no internal sparking, with a controlled operating temperature range, and with minimal spacing between components to prevent dust from collecting and potentially causing a short circuit. Internal sparking may be reduced by limiting power present on internal printed circuit boards (PCBs) of the drone. The drone 200 may include a first propeller 204A, a second propeller 204B, and a third propeller 204C for flying the drone. For example, the first, second, and third propellers 204A-C may each be attached to arms, with rotors of vertical axis for rotating the propellers. In some embodiments, the drone 200 may have more than or fewer than three propellers. Propellers, such as propeller 204B, may be adjustable to adjust a yaw of the propellers, allowing for more flexible drone movement. For example, rear motor 214 may adjust a yaw of the propeller 204B providing a much greater range of yaw than differential torque propeller control methods. The drone 200 may include an arm 206 extending from the main body 202 for holding sensing probes and/or electromagnets for attaching the drone to metal surfaces. For example, the arm 206 may include a mounting plate for attaching a common surface holding one or more sensing probes and/or electromagnets to the arm 206. The arm 206 may extend between two propellers of the drone, such as propellers 204A and 204C without interfering with operation of the propellers. The arm 206 may extend beyond the reach of the propellers, so that any common surface holding electromagnets and/or sensing probes may also avoid interfering with operation of the propellers. The arm 204 may, for example, be a fixed extension arm or a retractable arm. The drone 200 may further include a data acquisition module 212 for receiving data measured by probes attached to the arm 206. The data acquisition module 212 may include a wireless communications module, such as a wireless transceiver, for communicating with a base station. For example, the data acquisition module 212 may transmit parameters, such as measurements made by sensing probes, a power level of the drone, video data, and drone operation statistics, to a base station and may receive parameters from the base station, such as drone operation commands. The data acquisition module 212 may transmit measurements made by sensing probes in real time to a base station. For example, an operator may control the drone from the base station via instructions transmitted by the base station and received by the data acquisition module 212.

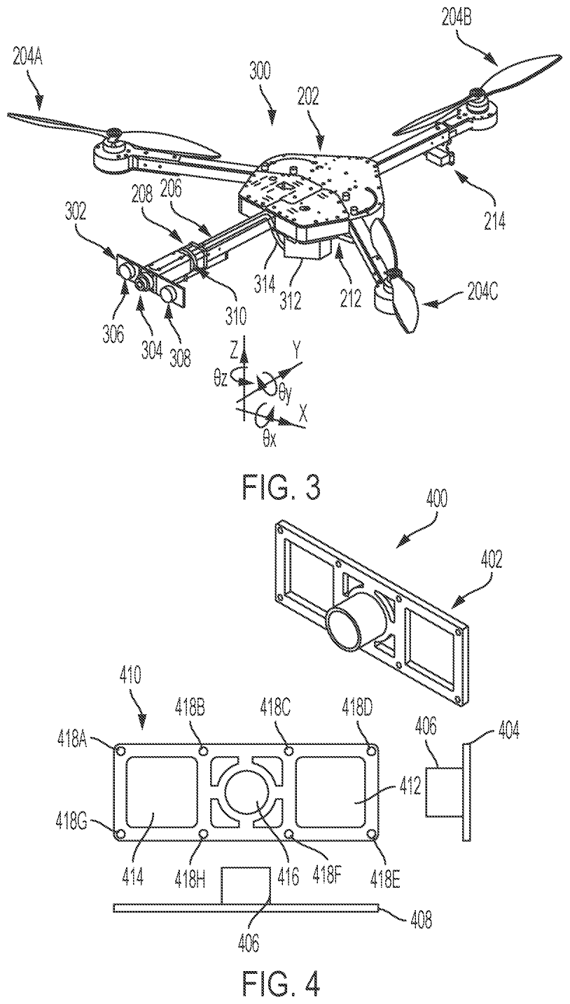

Sensing probes and electromagnets may be carried by a drone for attachment of the drone to a metal surface and measurement of one or more parameters of the metal surface. FIG. 3 shows an example drone 300 carrying a set of electromagnets and an acoustic probe. The drone 300 is similar to the drone 200, shown in FIG. 2, but has a sensing apparatus attached to the mounting plate 208 at the end of the arm 206. Sensors and/or electromagnets may be mounted on a common surface 302 that is attached to the mounting plate 208. The common surface 302 may, for example, be a mounting bracket or a metal plate. Electromagnets 306, 308 may be mounted on common surface 302 and may be electrically connected to a battery carried by drone 300. Electromagnets 306, 308 may, for example, be electro-permanent magnets (EPMs) or electromagnets (EMs). A sensing probe 304 may also be mounted on or extend through the common surface 302. Sensing probe 304 may, for example, be an acoustic sensing probe, such as an ultrasonic sensor probe. The common surface 302 may be positioned at the end of an arm, such that the drone 300 may place electromagnets 306, 308 and/or sensing probe 304 in contact with a metal surface without interfering with operation of a drone. For example, in order to obtain measurements of one or more parameters of a metal surface, the drone 300 may navigate to a position where electromagnets 306, 308 are in contact with a metal surface, and may activate electromagnets 306, 308 to electromagnetically attach the drone 300 to the metal surface. The sensing probe 304 may be positioned on the common surface 302 in a common plane with electromagnets 306, 308 such that when electromagnets 306, 308 are in contact with a metal surface, the sensing probe 304 is also in contact with the metal surface. The common surface 302 may be attached to the mounting plate 208 via an articulating module 310. The articulating module 310 may allow the common surface 302, and, by extension, the electromagnets 306, 308 and sensing probe 304 a degree of freedom of movement relative to the main body 202 of the drone 300. For example, the articulating module 310 may be an articulating joint. The articulating module 310 may allow six degrees of freedom of movement of the common surface 302, with respect to the main body 202, that can isolate the common surface 302 from movements of the main body 202 of the drone 300. For example, the articulating module 310 may allow the common surface, and thus the sensing probe 304 and electromagnets 306, 308 to maintain a position against a metal surface while measurements are being taken, even if the main body 202 of the drone 200 moves. Stable positioning of sensing probes, such as sensing probe 304, can allow for more accurate measurement of structure parameters.

In some embodiments, the drone 300 may include a reservoir 312 containing a gel for facilitating better acoustic coupling between a sensing probe, such as sensing probe 304 and a structure. The gel may, for example, be a coupling gel for ultrasonic testing that enhances sound transmission between the sensing probe and the surface of the structure. The gel may allow for collection of more accurate acoustic data for flaw detection, thickness gauging, flow metering, and acoustic emission testing. The gel may be delivered to the surface of the sensing probe 304 via an injector tube 314. For example, as the drone 300 approaches a surface for examination, a pump, such as a direct current (DC) pump, of the gel reservoir 312 may transmit gel through the injector tube 314 to a front face of the sensing probe 304. The pump of the gel reservoir 312 may operate on a timer configured to deliver enough gel to a front face of the sensing probe 304 to cover the sensing probe. In some embodiments, the pump 312 may be controlled remotely by an operator at a base station. Thus, the sensing probe 304 may be covered in a layer of gel prior to contact with a structure, allowing for more accurate measurement.

A mounting bracket 400, as shown in FIG. 4 may be used to house electromagnets and/or sensing probes. For example, a mounting bracket 400 may be, or may be used in combination with, a common surface 302, as described with respect to FIG. 3. A first perspective 402 of a mounting bracket shows an angular perspective of a mounting bracket. A side-view perspective 404 of a mounting bracket shows a bracket having a protrusion 406. The protrusion 406 may, for example, be a cylindrical protrusion, with a central aperture and may house a sensing probe. A front perspective 410 of the mounting bracket shows that the mounting bracket may include several openings. For example, the mounting bracket may include a first side opening 412 and a second side opening 414 for housing electromagnets. In some embodiments, the electromagnets may be mounted on a common surface behind the mounting bracket and may extend through first and second side openings 412, 414. The mounting bracket may also include a circular center opening 416 that may extend through the cylindrical protrusion 406. The mounting bracket may include other openings 418 A-G for, example, for attaching the mounting bracket to a common surface on which electromagnets and/or sensing probes may be mounted, such as by using screws, nails or other attachment mechanisms. A horizontal side view 408 of the mounting bracket shows the protrusion 406 extending from the main body of the bracket. Other forms of mounting brackets and/or plates may be used to hold electromagnets and/or sensing probes on the drone.

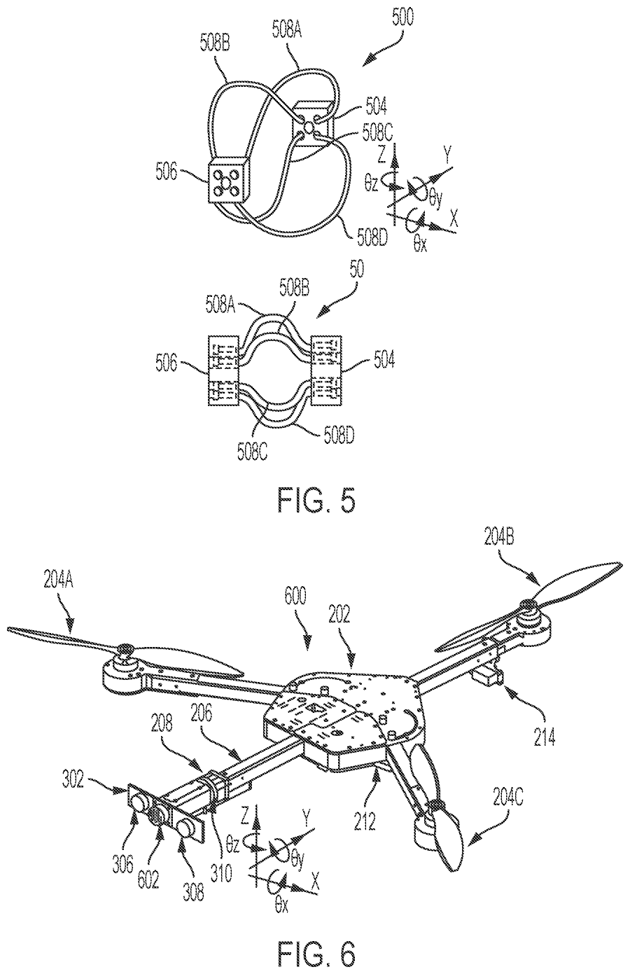

An articulating module may allow a common surface, and, by extension, electromagnets and/or sensing probes mounted on the common surface, freedom of movement with respect to movement of the drone. An example articulating module 500 is shown at two perspectives in FIG. 5. The articulating module may include a first rigid part 504 connected to a second rigid part 506 by one or more flexible means of attachment, such as attachment devices 508A-D. Attachment devices 508A-D may, for example, be elastic cables, such as elastic coiled hard cables. For example, attachment devices 508A-D may be made of stainless steel or another material. The attachment means 508A-D may, for example, have a mechanical memory, such that the first and second rigid parts 504, 506 maintain a constant position with respect to each other unless a force is exerted on one or both of the first and second rigid parts 504, 506 sufficient to overcome the mechanical memory of the attachment means 508A-D causing the first rigid part 504 to move with reference to the second rigid part 506. In some embodiments more than or fewer than four elastic coiled hard cables may be used to couple the first rigid part 504 to the second rigid part 506. The first and second rigid parts 504, 506 may, for example, be made of plastic, metal, or another rigid material. The first rigid part 504 may, for example, be attached to a common surface, such as common surface 302, on which electromagnets and/or sensing probes are mounted. For example, the first rigid part 504 may be attached to the common surface via screws, nails, an adhesive, or other attachment mechanism. The second rigid part 506 may, for example, be attached to a mounting plate, such as mounting plate 208 via an attachment mechanism such as screws, nails, an adhesive, or other attachment mechanism. The common surface 302 may thus be attached to the mounting plate 208 via an articulating module 310. The attachment means 508A-D may allow flexibility of movement of the first rigid part 504 and, by extension, common surface 302 with reference to the second rigid part and, by extension the mounting plate and main body of the drone. For example, elastic coiled hard cables coupled between the first rigid part 504 and the second rigid part 506 may allow electromagnets and/or sensing probes mounted on a common surface to maintain a position against a metal structure while a main body of a drone moves in relation to the position of the electromagnets and/or sensing probes against the metal structure. The articulating module 310 may allow for substantial out-of-plane motion of the drone. Thus, the articulating module 500 may allow flexibility of movement of sensing probes and/or electromagnets with reference to a main body of a drone while measurements are being taken by the sensing probes.

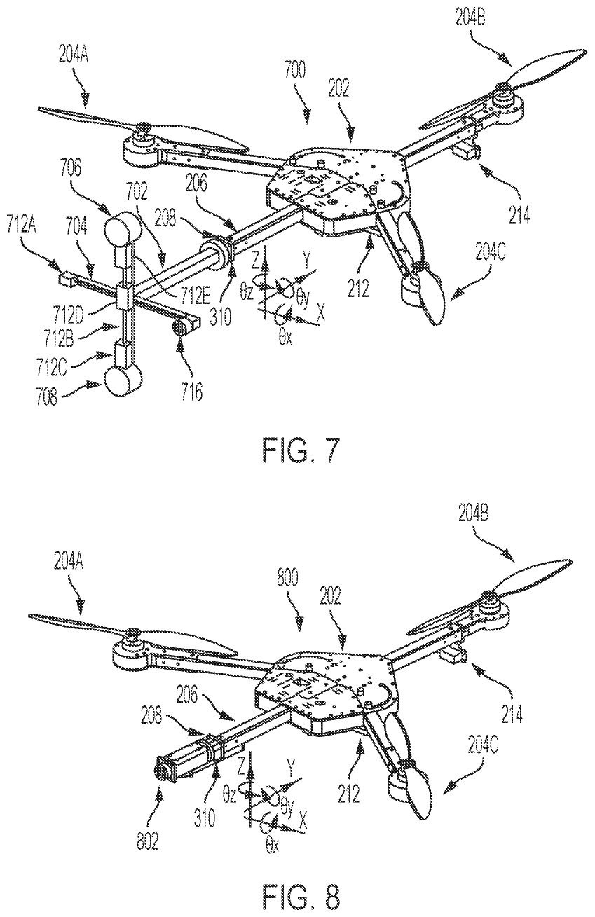

A variety of different sensing and electromagnetic configurations may be appended at the end of a drone arm. A drone 600, shown in FIG. 6, may include a common surface 302 to that of the drone 300 of FIG. 3. Instead of an ultrasonic sensing probe, as in FIG. 3 the drone may include an electromagnetic acoustic transducer sensor probe 602. Other examples of sensing probes that a drone may carry may include an electromagnetic acoustic transducer (EMAT) sensing probe, an X-Y encoder plotter, and an ultrasonic imaging probe. Sensing probes and electromagnets may also be mounted on common surfaces in configurations different from that of FIGS. 3 and 6. For example, FIG. 7 shows a drone carrying an EMAT sensing probe and an X-Y encoder plotter. The drone may be similar to the drone shown in FIGS. 3 and 6, but may include an arm extension 702 attached to the articulating module 310, extending the common surface further from a main body of the drone. The common surface 704 may have four arms. Electromagnets 706 and 708 may be attached at the ends of two arms of the common surface 704, and may be connected to a main battery by wires, such as wire 714. An EMAT sensing probe 716 may be connected at an end of a third arm of the common surface 704 and used to measure various parameters of a structure. In some embodiments, the common surface 704 may support coordinate measurement systems, such as a linear computer numerical control (CNC) modules 412A-E. Alternatively or additionally, the common surface 704 may support motor systems for manipulation of the common surface 704 and/or probes on the common surface, such as a three-dimensional printer z-axis slide stroke stage actuator motor. In an alternative sensing configuration, drone 800 of FIG. 8 may include an eddy current probe 802.

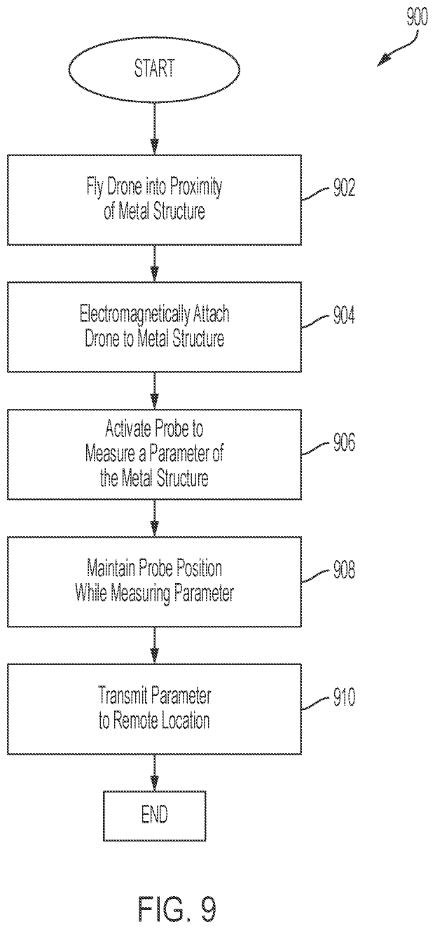

A drone carrying one or more sensing probes may be operated to measure one or more parameters of a structure. An example method 900 of operating a drone to measure one or more parameters of a structure is shown in FIG. 9. In some embodiments, a processor integrated within a drone according to any of the embodiments of this disclosure may control the drone according to the operations described in the method 900. In other embodiments, a processing system remote from the drone, such as a laptop on the ground, may wirelessly control the drone according to the operations described in the method 900. In further embodiments, the operations described in the method 900 may be performed by the drone under coordination between a processor in the drone and a remote processing system.

The method 900 may begin, at step 902, with flying a drone into proximity of a metal structure. A drone may be controlled manually to fly into proximity of a metal structure by an operator at a base station or may autonomously fly into proximity of a metal structure. Flying a drone into proximity of a metal structure may include flying a drone to an area within a predetermined distance of a metal structure. For example, flying a drone into proximity of a metal structure may include flying a drone into a position where one or more electromagnets and/or sensors of the drone are in contact with a surface of the metal structure. For example, electromagnets and/or sensors may be mounted on a common surface at an end of an arm extending from the drone. The drone may move to a position where the arm is extending from the body of the drone toward the surface of the metal structure and may horizontally move forward, toward the structure, until electromagnets and/or sensors mounted on the common surface are in contact with a surface of the metal structure. In some embodiments, a drone may be manually operated to fly to an area within a certain distance of a metal structure. Once the drone is within a certain distance of the metal structure, the drone may autonomously move into a position where one or more electromagnets and/or sensors carried by the drone are in contact with the metal structure.

At step 904, the drone may be electromagnetically attached to the metal structure. For example, once the drone has moved into proximity with the metal structure, one or more electromagnets carried by the drone may be activated to electromagnetically attach the drone to the metal structure. For example, when electromagnets mounted on a common surface with one or more sensing probes are in contact with the metal structure, the drone may autonomously, or in response to an instruction by an operator, activate the electromagnets to attach the drone to the structure.

At step 906, the drone may activate a probe to measure a parameter of the metal structure. For example, when the drone is moved to a position where electromagnets carried by the drone are in contact with a metal structure, a probe carried by the drone may also be in contact with the metal structure. When the electromagnets are activated and the drone is electromagnetically attached to the metal structure, the drone may activate the probe to inspect the structure by measuring one or more parameters of the structure. The probe may, for example, be an electromagnetic probe or an acoustic probe. An electromagnetic or acoustic sensing probe may emit electromagnetic and/or acoustic signals into the structure and may measure reflection of those signals to determine one or more properties of the structure. For example, the probe may include an ultrasonic testing probe, an electromagnetic acoustic transducer (EMAT) scanning probe, an ultrasonic imaging probe, an eddy-current testing probe, a camera for visual inspection of the structure, and other sensing probes. Properties measured by the probe may include a mechanical integrity of the structure, a wall thickness of the structure, a porosity of the structure, a material composition of the structure, a corrosion level of the structure, and video and image data relating to the structure. For example, the probe may conduct non-destructive testing to evaluate the structure for corrosion and/or flaws on or underneath the surface of the structure, such as thinning, dents, voids, pits, cracks in metals or composites, debonding, and delamination.

At step 908, a position of the probe may be maintained while the probe is measuring the parameter of the metal structure. For example, external forces such as wind, gravity, and other forces may cause the drone to move while the parameter is being measured. Movement of the probe while measurements are being taken may reduce the accuracy of measurements. The drone may include a variety of systems to enable the drone to maintain position and orientation while parameters are being measured. For example, the drone may include a GPS module to maintain a position of the drone. The drone may also include lasers to track and maintain a position of the drone. In some embodiments, the drone may include wind sensors to track wind movement. The drone may use data from position and motion measurement systems, such as GPS, laser tracking, and wind sensing systems to dampen movement and instability that the drone may encounter while measuring structural parameters. Such systems may allow the drone to hover in front of a structure without changing a position and orientation of a testing probe relative to a surface of the structure. In some cases, the drone may not be able to dampen all movement that may occur during measurement of parameters. In order to further stabilize a position of sensing probes and electromagnets relative to the surface of the metallic structure, an articulating module may be coupled between electromagnets and/or probes and a main body of the drone. For example, an articulating module may be coupled between a common surface on which electromagnets and/or sensing probes are mounted and an arm extending from the main body of the drone. The articulating module may allow the drone up to six degrees of freedom of movement with respect to the electromagnets and or sensors positioned on the surface of the metal structure. Thus, the drone may move slightly while measurements are being obtained, but the probe may maintain its position against the surface, held in place by one or more electromagnets, by taking advantage of the flexibility provided by the articulating module. Thus, a position of a probe against a metal structure may be maintained while structural parameters are being measured, allowing for accurate parameter measurement.

At step 910, the parameters measured by the probe may be transmitted to a base station. For example, parameters measured by a probe may be transmitted to a base station in real time. Data from A and B scans may be displayed in real time for analysis by an operator. Display of A scans may include display of ultrasonic energy received by a sensing probe as a function of time. For example, in A scan displays a relative amount of received energy may be plotted along a vertical axis, while elapsed time, such as the sound energy travel time within a material of a structure, may be displayed along a horizontal axis. Display of B scans may include presentation of a cross-sectional view of a sensed structure, showing various sensed properties of the structure. The parameters may be transmitted via a wireless connection, such as a cellular, radio, Bluetooth, or Wi-Fi connection. The parameters may be received at a base station, such as a laptop computer, data center, or other base station, for review and analysis by an operator. In some embodiments, a drone may autonomously fly to, attach to, and measure parameters of multiple different areas of a structure. Thus, a drone may be used to measure structural parameters in situations where measurement of such parameters may be unsafe, expensive, and/or time consuming when performed manually by personnel.

The schematic flow chart diagram of FIG. 9 is generally set forth as logical flow diagrams. As such, the depicted order and labeled steps are indicative of aspects of the disclosed method. Other steps and methods may be conceived that are equivalent in function, logic, or effect to one or more steps, or portions, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method, comprising:
flying a drone into proximity of a metal structure for inspection;
activating an electromagnet to electromagnetically attach the drone to the metal structure for inspection; and
activating a probe to inspect the metal structure by measuring a parameter of the metal structure.

2. The method of claim 1, wherein the electromagnet is located at an end of an arm extending from a main body of the drone, and wherein flying the drone into proximity of the metal structure comprises positioning the electromagnet at the end of the arm to be in contact with the metal structure.

3. The method of claim 2, further comprising maintaining contact between the electromagnet and the metal structure by flexibly adjusting an angle at which the electromagnet is attached to the arm of the drone based on motion of the drone relative to a point at which the electromagnet is electromagnetically attached to the metal structure.

4. The method of claim 1, further comprising transmitting the parameter to a remote location.

5. The method of claim 1, wherein the electromagnet is in contact with the metal structure when the electromagnet is activated, further comprising maintaining contact between the electromagnet and the metal structure by dampening extraneous forces applied to the drone.

6. The method of claim 1, wherein activating the probe comprises activating an electromagnetic probe.

7. The method of claim 1, wherein activating the probe comprises activating an acoustic probe.

8. The method of claim 1, wherein measuring the parameter comprises measuring at least one of mechanical integrity, wall thickness, porosity, material composition, and corrosion level.

9. An apparatus, comprising:
a payload configured to attach to a drone, the payload comprising:
a first electromagnet; and
a probe,
wherein the probe and the first electromagnet are exposed on a common surface.

10. The apparatus of claim 9, wherein the payload further comprises an articulating module coupled to the common surface, and wherein the articulating module provides the common surface with freedom of movement with respect to the drone.

11. The apparatus of claim 10, wherein the articulating module comprises:
a first rigid attachment module;
a second rigid attachment module; and
one or more elastic cables coupling the first rigid attachment module to the second rigid attachment module,
wherein the first rigid attachment module is configured to attach to the common surface and the second rigid attachment module is configured to attach to the drone.

12. The apparatus of claim 10, wherein the payload further comprises an arm configured to attach to a main body of the drone such that the surface on which the first electromagnet and the probe are exposed is extended away from the main body of the drone, and wherein the articulating module couples the surface on which the probe and the first electromagnet are exposed to the arm.

13. The apparatus of claim 9, wherein the probe comprises an electromagnetic probe.

14. The apparatus of claim 9, wherein the probe comprises an acoustic probe.

15. An apparatus, comprising:
a drone comprising:
a first electromagnet for electromagnetically attaching the drone to a surface of a metal structure; and
a probe for measuring one or more parameters of the metal structure.

16. The apparatus of claim 15, wherein the first electromagnet and the probe are located on a common surface such that the electromagnet and the probe are in contact with the metal structure when the drone is electromagnetically attached to the metal structure.

17. The apparatus of claim 16, wherein an articulating module is coupled between the common surface and the drone to allow the common surface freedom of movement with respect to a main body of the drone.

18. The apparatus of claim 17, wherein the articulating module comprises:
a first rigid attachment module;
a second rigid attachment module; and
one or more elastic cables coupling the first rigid attachment module to the second rigid attachment module,
wherein the first rigid attachment module is attached to the common surface and the second rigid attachment module is attached to a main body of the drone.

19. The apparatus of claim 18, wherein the one or more elastic cables comprise a predetermined mechanical memory such that the first rigid attachment module maintains a fixed position relative to the second rigid attachment module unless a force greater than a predetermined force is exerted on the second rigid attachment module relative to the first rigid attachment module.

20. The apparatus of claim 15, wherein the drone comprises a processor configured to control the drone, wherein the processor is configured to perform steps comprising:
flying a drone into proximity of a metal structure for inspection;
activating the first electromagnet to electromagnetically attach the drone to the metal structure for inspection; and
activating the probe to inspect the metal structure by measuring a parameter of the metal structure.
